(19) United States
(12) Patent Application Publication
(10) Pub. No.: US 2011/0082746 A1
(43) Pub. Date: Apr. 7, 2011

(54) Systems and Methods for Providing Location Based Promotions and Feedback Services

(76) Inventors: Christopher Rice, Parsippany, NJ (US); Alex Varshavasky, Chatham, NJ (US)

(21) Appl. No.: 12/574,346

(22) Filed: Oct. 6, 2009

(51) Int. Cl. G06Q 30/00; G01C 21/00; H04M 3/493

(52) U.S. Cl. 705/14.56; 705/14.58; 701/213; 455/414.2

(57) ABSTRACT

Systems, methods, and devices for providing location based promotions and feedback services on communications networks are disclosed. Location information corresponding to an entity's location can be stored. Location data relating to a device can be received and compared to the location information to determine if the device is at or near the entity's location. If the device is determined to be at or near the entity's location, a feedback request can be sent to the device. In some embodiments, the device can be given a choice to “opt-in” or “opt-out.” If a device “opts-in,” then feedback associated with the entity can be received. Promotions can be sent to the device based upon the submission of feedback, or based upon the content of the feedback. Feedback can be sorted, filtered, and/or prioritized. Methods and computer-readable media embodying methods for providing location based promotions and feedback services also are disclosed.

### TECHNICAL FIELD

The present disclosure relates generally to communications networks and, more particularly, to systems and methods for providing location based promotions and feedback services.

### BACKGROUND

Over the past several years, the use of mobile communications devices and networks has increased. Some modern communications networks now include devices and software for providing users with location based services (LBS) such as navigation. Additionally, it may be possible to use the location of devices operating on a network to provide device users with services or features tailored to a particular location. It also may be possible for network operators to use location information to analyze network infrastructure, usage patterns, and the like, and/or to monitor maintenance, planning, and operational issues, if desired.

Some portable devices now include global positioning system (GPS) capability for determining the location of the device for navigation, emergency response, or other purposes. The location of devices can be obtained using other systems and methods, for example, triangulation using network and/or WIFI® resources, assisted GPS (A-GPS), satellite links, other systems and methods, and the like.

With the increasing sophistication of communications devices, communications networks, and communications device users, some enhanced device capabilities are becoming more common. For example, visual voicemail, navigation applications, Internet applications, e-commerce applications, social networking applications, and the like, which were until recently unavailable for many communications devices, are becoming popular features and/or applications for some accounts and devices. Other sophisticated device and network capabilities can be implemented by communications network operators, application authors, and/or communications device manufacturers to provide users with new services.

### SUMMARY

According to exemplary embodiments of the present disclosure, a user is provided with the ability to receive location based feedback requests on communications networks. According to some embodiments of the present disclosure, location information can be associated with an entity, for example, a business. The location of a mobile device can be monitored, periodically polled, queried, or submitted by a user operating the mobile device upon being prompted by the network, a business, or another entity. In some exemplary embodiments, a location based feedback server (LBFS) can generate and transmit, or direct other network elements to generate and transmit, an “opt-in” request and/or a request for feedback data to the device that is proximate to the location associated with a business or other entity.

In some embodiments, an “opt-in” request is sent to the device. If an “opt-in” request is sent to the device, the device can transmit an “opt-in” response, an “opt-out” response, and/or feedback data to the LBFS. The LBFS can analyze the received feedback data, extract private data and/or feedback from the feedback data, associate a user identification with the feedback, and/or transmit or trigger transmission of the feedback to a location based promotion server (LBPS) directly, or via a web-based feedback system that sorts the feedback for publishing purposes. The LBPS can review the feedback and generate a promotion for delivery to the user or device that submitted the feedback data. The promotion can be an advertisement, a discount code, a coupon, information regarding special offers, a promotional message, and/or other advertising or promotional information from the entity associated with the feedback, or another establishment that may be of interest to the user of the device that submitted the feedback data. The LBPS can send the promotion to the device, or if the identity of the user or device is not shared with the LBPS, the LBPS can send the promotion to a network node for forwarding to the device that submitted the feedback data.

Requesting feedback data from a device currently located at or near an entity can result in higher participation rates, with respect to providing feedback, among those who visit the entity. Additionally, the feedback may be provided in a more timely and accurate manner, as opposed to other request methods, since the feedback may be submitted at the time the user is at or near the entity. Other benefits also are contemplated. For example, since the feedback request can be automated and can be delivered in a digital format, the costs associated with soliciting and collecting feedback can be reduced. Furthermore, since the feedback data is electronically submitted, the feedback can be analyzed and categorized by electronic devices such as, for example, a computer, a web server, combinations thereof, and the like.

Accordingly, an exemplary embodiment of the present disclosure is directed to a system for obtaining location based feedback from a device operating on a communications network for providing a location based feedback service. The system can include a location based feedback server. The feedback server can include a memory for storing computer-readable instructions. Execution of the computer-readable instructions by a processor can make the location based feedback server operable to receive location information indicating a location at which the device is located and compare the location information to location data indicating an entity location. The entity location can be associated with an entity that participates in the location based feedback service.

In some embodiments, the location based feedback server can determine that the device is at the entity location and can transmit a feedback data request to the device. The feedback data request can include a request for the device to submit feedback relating to the entity. If feedback data is received at the location based feedback server, the location based feedback server can extract feedback from feedback data received from the device and can send the feedback to a location based promotion server.

In some embodiments, the computer-readable instructions make the location based feedback server operable to determine a delivery method supported by the device prior to transmitting the feedback data request to the device. In some embodiments, the computer-readable instructions make the location based feedback server operable to extract the identification information from the feedback data received from the device.

In some embodiments, the computer-readable instructions make the location based feedback server further operable to generate an “opt-in” notification for delivery to the device, recognize received data as an “opt-in” response sent by the device, and transmit, to the device, the feedback data request. The feedback data request can include a feedback form.

In some embodiments, the system includes computer-readable instructions, executable by a processor to make the location based feedback server operable to generate a user identification, store the user identification and a device identifier in a storage location accessible by the location based feedback server, and append the user identifier to the feedback to create anonymous feedback.

In some embodiments, the computer-readable instructions make the location based feedback server operable to transmit the anonymous feedback to a location based promotion server. In some embodiments, the computer-readable instructions make the location based feedback server operable to receive a promotion from a location based promotion server.

In some embodiments, the computer-readable instructions make the location based feedback server operable to receive a promotion from a location based promotion server. The promotion can include the user identifier. The location based feedback server can determine the device identifier by accessing the storage location and retrieving the device identifier associated with the use identifier. The location based feedback server can transmit, or trigger the transmission of, the promotion to the device.

In some of the above embodiments, the location information includes data obtained at the device using a Global Positioning Service (GPS) receiver.

Another exemplary embodiment of the present disclosure is directed to a method for providing location based feedback services to a device operating on a communications network. The method can include associating an entity location with an entity that participates in the location based feedback service and storing, at a storage device, data indicating the entity location and the associated entity. The method also can include receiving location information indicating a location at which the device is located and comparing, at a location based feedback server, the location information to the entity location. The method also can include determining, based upon the comparing, that the device is at the entity location and transmitting a feedback data request to the device. The feedback data request can include a request for the device to submit feedback relating to the entity. The method also can include extracting feedback from feedback data received from the device, wherein the feedback data can include the feedback and identification information relating to the device. The method can include sending the feedback to a location based promotion server.

In some embodiments, the method further includes generating an “opt-in” notification for delivery to the device, recognizing data received at the location based feedback server as an “opt-in” response sent by the device, and transmitting, to the device, the feedback data request. The feedback data request can include a feedback form.

In some embodiments, the method further includes generating a user identification, storing the user identification and a device identifier in a storage location accessible by the location based feedback server, and appending the user identifier to the feedback to create anonymous feedback. Transmitting the feedback data request to the device can include triggering delivery of the feedback data request. The method also can include sending, to a system associated with the entity, the feedback.

In some embodiments, associating the entity location with the entity can include storing location data corresponding to a geographic location and indicating that the geographic location corresponds to a place of business associated with the entity.

In some embodiments, the method further includes receiving, at the location based feedback server, a promotion including the user identifier, determining the device identifier by accessing the storage location and retrieving the device identifier associated with the user identifier, and transmitting the promotion to the device. In some embodiments, the method includes charging a fee to the entity for the feedback. In some embodiments, the location data includes an Internet Protocol (IP) address of a short range radio beacon and receiving location information includes receiving an indication that the device is within a transmission range of the short range radio beacon.

Another exemplary embodiment of the present disclosure is directed to a computer readable medium. The computer readable medium includes computer readable instructions that, when executed, cause a location based feedback server to provide a location based feedback service. The server can store, at a storage device, data indicating an entity location and an entity associated with the entity location. The entity can include an entity that participates in a location based feedback service. The instructions can further cause a location based feedback server to receive, or to recognize received data as, data indicating a location of a mobile communications device. The location based feedback server can compare the location information to the entity location to determine that the device is at the entity location.

Additionally, the location based feedback server can recognize received data as feedback data received from a mobile communications device. The feedback data can include feedback and identification information relating to the device, and can be received in response to a feedback data request sent to the device by the location based feedback server or another device. The location based feedback server can extract feedback from the feedback data and can send the feedback to a location based promotion server.

In some embodiments, the computer readable medium further includes computer readable instructions that, when executed, cause the location based feedback server to receive, or to recognize data received as, a promotion for the device. The location based feedback server can transmit or trigger transmission of the promotion to the device.

### BRIEF DESCRIPTION OF THE DRAWINGS

FIG. 1 schematically illustrates a system for providing location based promotions and feedback services, according to an exemplary embodiment of the present disclosure.

FIG. 2 schematically illustrates a device with which embodiments of the present disclosure can be implemented, according to an exemplary embodiment of the present disclosure.

FIG. 3 schematically illustrates a location based feedback server, according to an exemplary embodiment of the present disclosure.

FIG. 4 schematically illustrates a method for sending a feedback data request, according to an exemplary embodiment of the present disclosure.

FIG. 5 schematically illustrates a method for generating location based feedback on a communications network, according to an exemplary embodiment of the present disclosure.

FIG. 6 schematically illustrates a method for receiving location based feedback, according to an exemplary embodiment of the present disclosure.

FIG. 7 schematically illustrates a method for generating a promotion, according to an exemplary embodiment of the present disclosure.

### DETAILED DESCRIPTION

As required, detailed embodiments of the present disclosure are disclosed herein. It must be understood that the disclosed embodiments are merely exemplary examples of the disclosure that may be embodied in various and alternative forms, and combinations thereof. As used herein, the word “exemplary” is used expansively to refer to embodiments that serve as an illustration, specimen, model or pattern. The figures are not necessarily to scale and some features may be exaggerated or minimized to show details of particular components. In other instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

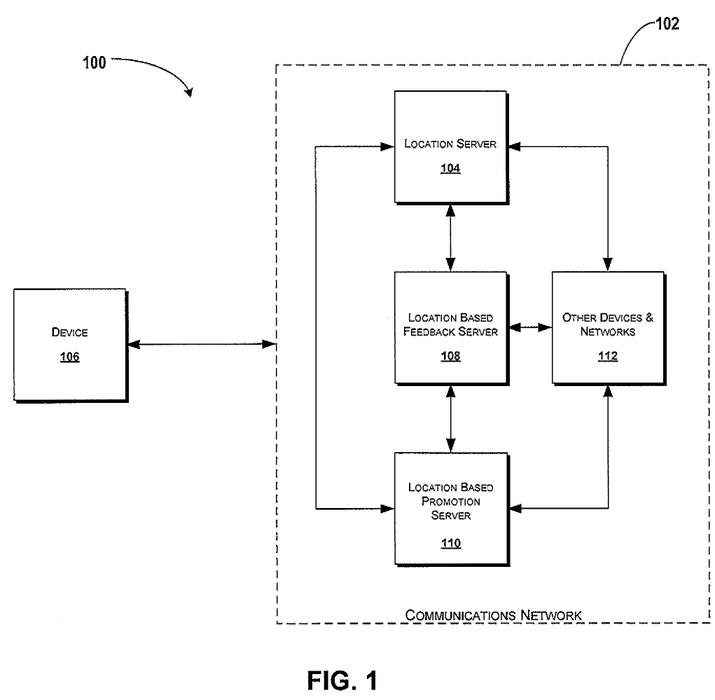

Referring now to the drawings in which like numerals represent like elements throughout the several views, FIG. 1 schematically illustrates a system 100 for providing location based promotions and feedback services, according to an exemplary embodiment of the present disclosure. The system 100 can include a communications network 102. The communications network 102 can include a cellular network, a packet data network, for example, the Internet (Internet), a circuit switched network, for example, a publicly switched telephone network (PSTN), other networks, combinations thereof, and the like. In the described exemplary embodiments, the communications network 102 is described as a cellular network, though alternative and/or additional networks can be used in addition to, or instead of, a cellular network.

The cellular network can include various components such as, but not limited to, base transceiver stations (BTS's), Node-B's, base station controllers (BSC's), radio network controllers (RNC's), mobile switching centers (MSC's), short message service centers (SMSC's), multimedia messaging service centers (MMSC's), home location registers (HLR's), visitor location registers (VLR's), charging platforms, billing platforms, voicemail platforms, GPRS core network components, location service nodes, Internet protocol multimedia subsystem (IMS) components, and the like. The cellular network also can include radios and nodes for receiving and transmitting voice, data, and combinations thereof to and from radio transceivers, networks, and the Internet.

The cellular network can be configured as a 2G GSM (Global System for Mobile communications) network, and can provide data communications via GPRS (General Packet Radio Service) and EDGE (Enhanced Data rates for GSM Evolution). Additionally, the cellular network can be configured as a 3G UMTS (Universal Mobile Telecommunications System) network and can provide data communications via the HSPA (High-Speed Packet Access) protocol family, for example, HSDPA (High-Speed Downlink Packet Access), EUL (Enhanced Uplink) or otherwise termed HSUPA (High-Speed Uplink Packet Access), and HSPA+ (Evolved HSPA). The cellular network is also compatible with future mobile communications standards including, but not limited to, pre-4G and 4G, for example.

It should be appreciated that substantially all of the functionality described with reference to the communications network 102 can be performed by a cellular network alone, or in combination with other networks, network elements, and the like, and that some elements are not illustrated. While the communications network 102 will be described herein as a cellular network, it should be understood that other networks can implement the various embodiments of the present disclosure.

The communications network 102 also can include a location server 104. In some embodiments, the location server 104 includes one or more hardware modules and/or software modules. The system 100 also can include a device 106 in communication with the communications network 102, one or more location based feedback servers 108 (LBFS), and one or more location based promotion servers 110 (LBPS). The LBFS 108 and the LBPS 110 can reside on or can be in communication with, the communications network 102.

In some embodiments, the location server 104 determines and reports the location of a device 106. In some embodiments, the device 106 determines the location of the device 106 and communicates the determined location to the location server 104. In some embodiments, the device 106 can determine its location using GPS or other location services, for example, and communicate location information to the location server 104 upon determination of the location information, at various time or location intervals, upon occurrence of trigger events such as, for example, dialing of an emergency number or initiating other communications features of the device 106, upon receiving location requests from external networks, users, programs and/or applications, combinations thereof, and the like.

In some embodiments, the location server 104 can retrieve location information at the request of one or more network nodes and/or devices. It should be understood that the location server 104 can use other network elements to determine the location of a device 106. In some embodiments, for example, the location server 104 uses network elements to determine location of the device 106 using triangulation of network signals, by sensing proximity of the device 106 to a short range beacon, or by using other network elements or signals.

The location server 104 can be replaced, in some embodiments, with other devices and/or software. In some embodiments, the functions of the location server 104 are provided by the device 106, an LBFS 108, an LBPS 110, another device, combinations thereof, and the like. In some embodiments, the device 106, the LBFS 108, and/or the LBPS 110 can determine the location of the device 106. In some embodiments, the LBFS 108 and/or the LBPS 110 can query the device 106 and/or another location component of the communications network 102, and the device 106 and/or the other location component can determine and/or provide the location of the device 106.

The LBFS 108 can use the location information received from the location server 104 or the device 106, and can compare the location information to location data associated with the location of an entity participating in the location based feedback service. If the device 106 is determined to be at or near the location of the entity, the LBFS 108 can trigger requests for feedback, as will be explained below. Additionally, the LBFS 108 can receive submitted feedback data, extract private data and/or feedback from the feedback data, and forward the feedback to other network elements or other devices. As discussed above, the device 106 can determine its location using, for example, GPS, and can provide its location to the location server 104 and/or the LBFS 108. In the described embodiments, it is assumed that no location server 104 is needed. Rather, the device 106 can determine its location, or a location device, for example, a WIFI® or BLUETOOTH® device, can be in communication with the LBFS 108 and can detect the presence of the device 106.

The LBPS 110 can be accessible by the LBFS 108 and/or the device 106, as well as other devices and networks 112. In some embodiments, for example, the LBPS 110 is a server operating on the Internet and can be accessible by authorized devices in connection with the Internet. In some embodiments, the functions of the LBPS 110 are provided by the LBFS 108, or are provided by execution of instructions stored in a memory associated with the LBFS 108, the device 106, a web server in communication with the LBFS 108 or the device 106, or another device.

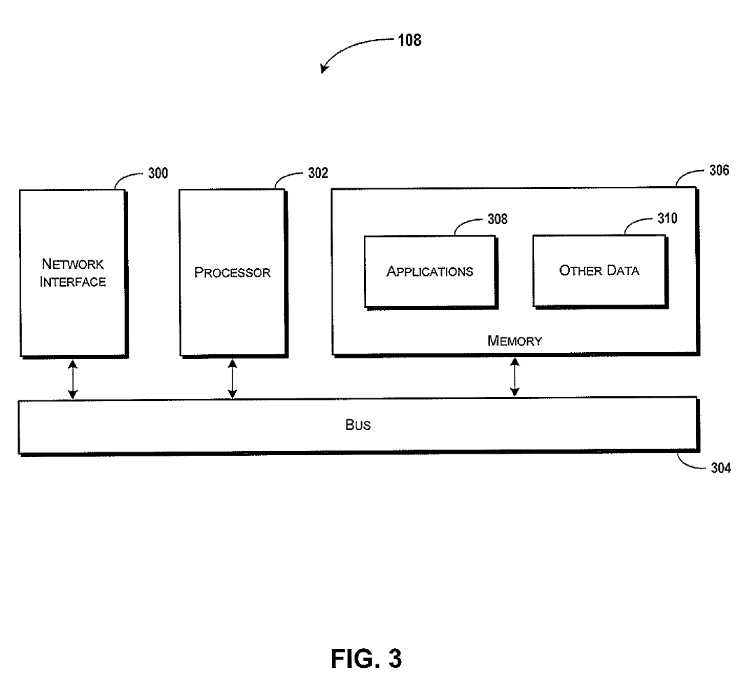

The architecture of the LBPS 110 can be substantially similar to the architecture of the LBFS 108, as will be described with reference to FIG. 3 below. Thus, while the architecture of the LBPS 110 is not separately illustrated, it should be understood that the LBPS 110 can include one or more memory devices, one or more processors, one or more network interfaces and data/memory busses, and one or more applications, programs, and/or software modules, as described with reference to the LBFS 108 illustrated in FIG. 3.

Returning to FIG. 1, the location server 104, the LBFS 108, the device 106, and/or the LBPS 110 can be in communication with other devices and networks 112. The other devices and networks 112 can be devices and networks in communication with, or existing on, the communications network 102. The other devices and networks 112 can include, for example, GPS networks, location beacons, billing or charging modules, Internet web servers, intranet devices, databases, short message service centers (SMSC's), multimedia message service centers (MMSC's), email servers, wireless networking devices, wired networking devices, combinations thereof, and the like.

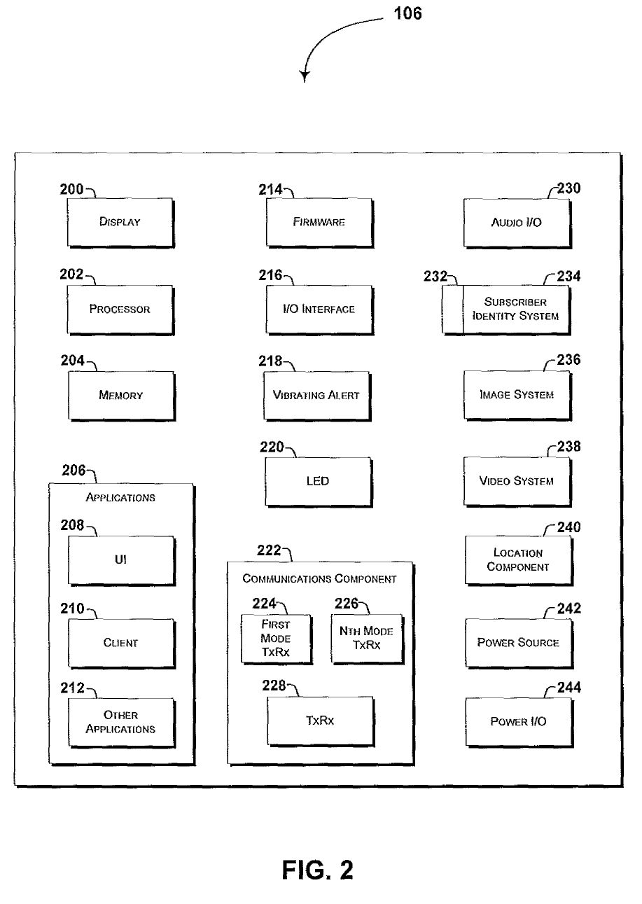

FIG. 2 illustrates a schematic block diagram of a device 106 for use in accordance with exemplary embodiments of the present disclosure. Although connections between the components are not illustrated in FIG. 2, it should be understood that the components can interact with each other to carry out functions of the device 106.

It should be understood that FIG. 2 and the following description are intended to provide a brief, general description of a suitable environment in which the various aspects of some embodiments of the present disclosure can be implemented. While the description refers to computer-readable instructions, the present disclosure also can be implemented in combination with other program modules and/or as a combination of hardware and software in addition to, or in stead of, computer readable instructions. The term “application,” or variants thereof, is used expansively herein to include routines, program modules, programs, components, data structures, algorithms, and the like. Applications can be implemented on various system configurations, including single-processor or multiprocessor systems, minicomputers, mainframe computers, personal computers, hand-held computing devices, microprocessor-based, programmable consumer electronics, combinations thereof, and the like.

The device 106 can be a multimode headset, and can include a variety of computer-readable media, including volatile media, non-volatile media, removable media, and non-removable media. The term “computer-readable media” and variants thereof, as used in the description and claims, can include volatile and/or non-volatile, removable and/or non-removable media such as, for example, RAM, ROM, EEPROM, flash memory or other memory technology, CD ROM, DVD, or other optical disk storage, magnetic tape, magnetic disk storage or other magnetic storage devices, or any other medium that can be used to store the desired information and that can be accessed and/or executed by the device 106.

The device 106 can include a display 200 for displaying multimedia such as, for example, text, images, video, telephony functions such as Caller ID data, setup functions, menus, music, metadata, messages, wallpaper, graphics, Internet content, feedback forms, “opt-in” notifications, advertisements or other promotions, device status, preferences settings, map data, navigation data, location data, and the like. The device 106 can include a processor 202 for controlling, executing, and/or processing data. A memory 204 can interface with the processor 202 and can store data. The data stored by the memory 204 can include computer-readable instructions for execution by the processor 202. The computer-readable instructions can include, for example, the applications 206.

The applications 206 can include, for example, location applications, navigation applications, web browsing software, feedback applications, text input software, mapping software, audio player software, video playback software, voicemail software, audio playback software, music player software, email software, messaging software, combinations thereof, and the like.

The applications 206 also can include a user interface (UI) application 208. The UI application 208 can interface with a client 210 (e.g., an operating system) to facilitate user interaction with device functionality and data, for example, browsing the Internet, inputting and/or submitting feedback or ratings information, displaying promotional messages or promotions, displaying “opt-in” or “opt-out” notifications, answering/initiating calls, accepting/outputting navigation data, entering/deleting data, configuring settings, address book manipulation, multimode interaction, and the like. The applications 206 also can include other applications 212 such as, for example, firmware, navigation software, location sharing software, visual voicemail software, add-ons, plug-ins, voice processing, voice recording, messaging, e-mail processing, video processing, image processing, archival applications, music playback, combinations thereof, and the like. The applications 206 can be stored in the memory 204 and/or in a firmware 214 as executable instructions, and can be executed by the processor 202. The firmware 214 also can store code for execution during initialization of the device 106.

The device 106 also can include an input/output (I/O) interface 216 for input/output of data and/or signals. The I/O interface 216 can be a hardwire connection, such as, for example, a USB port, a mini-USB port, an audio jack, a PS2 port, an IEEE 1394 port, a serial port, a parallel port, an Ethernet (RJ48) port, a telephone (RJ11) port, and the like, and can accept other I/O devices such as, for example, keyboards, keypads, mice, interface tethers, stylus pens, printers, thumb drives, touch screens, multi-touch screens, touch pads, trackballs, joy sticks, microphones, remote control devices, voice control interfaces, monitors, displays, liquid crystal displays (LCD's), combinations thereof, and the like. It should be appreciated that the I/O interface 216 can be used for communications between the device 106 and network and/or local devices.

The device 106 can include a vibrating alert 218 for providing a vibration alert function for the device 106. The device 106 also can include one or more light emitting diodes 220 (LED's) for providing device status information, visual alerts, warnings, and the like.

The device 106 can include a communications component 222. The communications component 222 can interface with the processor 202 to facilitate wired/wireless communications with external systems including, for example, a communications network 102, one or more location servers 104, LBFS's 108, LBPS's 110, VoIP networks, local area networks (LAN's), wide area networks (WAN's), metropolitan area networks (MAN's), personal area networks (PAN's), and other devices and networks 112, which can be implemented using WIFI®, WIMAX®, BLUETOOTH®, near-field communications (NFC), infrared, infrared data association (IRDA), other radio frequency (RF) applications, combinations and/or improvements thereof, and the like. The communications component 222 can be used instead of, or in addition to, the I/O interface 216.

The communications component 222 also can include a multimode communications subsystem for providing cellular communications via different cellular technologies. For example, the communications component 222 can include a first cellular transceiver 224 that operates in one mode, for example, GSM, and an Nth transceiver 226 that operates in a different mode, for example, UMTS. Although only two transceivers 224, 226 are illustrated, it should be appreciated that more than two transceivers can be included in the device 106. The communications component 222 also can include a transceiver 228 for unlicensed communications using technology such as, for example, WIFI®, WIMAX®, BLUETOOTH®, infrared, IRDA, NFC, RF, and the like.

The communications component 222 also can facilitate communications reception from terrestrial radio networks, digital satellite radio networks, Internet-based radio services networks, combinations thereof, and the like. The communications component 222 can process data from a network such as, for example, the Internet, a corporate intranet, GPS networks, a home broadband network, and the like, via an internet service provider (ISP), a digital subscriber line (DSL) provider, a cable provider, and/or a broadband provider. It should be appreciated that the communications component 222 can include, or can be connected to, one or more antennae through which data can be transmitted and/or received.

Audio capabilities can be provided by an audio I/O component 230 that can include, but is not limited to, speakers to output audio signals, microphones to collect audio signals, and I/O ports such as, for example, headphone and/or microphone jacks, to input and output audio signals. The audio I/O component 230 can include more than one speaker, including, for example, an earpiece speaker, a loudspeaker, a ringer, and the like.

The device 106 can include a slot interface 232 for accommodating a subscriber identity system 234 such as, for example, a subscriber identity module (SIM) or universal SIM (USIM). It should be understood that the subscriber identity system 234 can be manufactured into the device 106, thereby obviating the need for a slot interface 232. In some embodiments, the subscriber identity system 234 can store certain features, account information, user information, rules, policies, models, and the like. The subscriber identity system 234 can be programmed by a manufacturer, a retailer, a customer, a network operator, and the like.

The device 106 can include an image capture and processing system 236 (image system). Photos and/or videos can be obtained via an associated image capture subsystem of the image system 236, for example, a camera. The device 106 also can include a video system 238 for capturing and recording video content. The video system 238 can provide video data to various applications 206, such as, for example, video teleconferencing applications, video compression applications, video messaging applications, video sharing applications, and the like.

A location component 240 can be included to send and/or receive signals for use in determining location. As such, the location component 240 can receive, for example, GPS data, A-GPS data, data transmitted via WIFI®, data transmitted via WIMAX®, cellular network triangulation data, and/or combinations thereof, and the like. The location component 240 can receive and/or transmit signals via one or more antennae. The location component 240 can interface with cellular network nodes, telephone lines, satellites, location transmitters and/or beacons, wireless network transmitters and receivers, for example, WIFI® hotspots, radio transmitters, combinations thereof, and the like. The device 106 can obtain, generate, and/or receive data to identify its location, or can transmit data used by other devices to determine the device 106 location. The device 106 can include a power source 242 such as batteries and/or other power subsystems (AC or DC). The power source 242 can interface with an external power system or charging equipment via a power I/O component 244.

FIG. 3 schematically illustrates a block diagram of the LBFS 108, according to an exemplary embodiment of the present disclosure. The LBFS 108 can be a combination of hardware and software, and can exist as a node upon, or in communication with, the communications network 102, as explained above with reference to FIG. 1. It should be appreciated that the functionality of the LBFS 108 can be included as a software module executed by a hardware module associated with the communications network 102. As such, while the LBFS 108 is described as a hardware device with associated software, it should be appreciated that the software and hardware devices can be located remote from each other. The LBFS 108 is illustrated and described as a unitary device for ease and clarity of description, and not to limit the scope of the disclosure.

As illustrated in FIG. 1, The LBFS 108 can be in communication with one or more networks and/or devices such as, for example, the communications network 102, the location server 104, the device 106, the LBPS 110, the other devices and networks 112, combinations thereof, and the like, via one or more network interfaces 300 (FIG. 3). In some embodiments, the functions of the location server 104, the LBFS 108, and the LBPS 110 are performed by a single device and/or a single software module executed by one or more hardware modules. The location server 104, the LBFS 108, and the LBPS 110 are illustrated and described herein as three distinct and separate devices to clarify the description thereof.

The network interface 300 can be operatively linked and in communication with one or more processors 302 via one or more data/memory busses 304. The processor 302 can be operatively linked and in communication with one or more memory devices 306 via the data/memory bus 304. The processor 302 can execute computer-readable instructions, for example, computer-readable instructions stored in the memory 306, to perform various functions. Execution of the computer-readable instructions can cause the LBFS 108 to perform various functions, for example, the functionality of the LBFS 108 described below with reference to FIGS. 3-7.

The word “memory,” as used herein to describe the memory 306, collectively includes all memory types associated with the LBFS 108 such as, but not limited to, processor registers, processor cache, random access memory (RAM), read only memory (ROM), other volatile memory forms, and non-volatile, semi-permanent or permanent memory types, for example, tape-based media, optical media, flash media, hard disks, combinations thereof, and the like. While the memory 306 is illustrated as residing proximate the processor 302, it should be understood that the memory 306 can be a remotely accessed storage system, for example, a server and/or database on the communications network 102, a remote hard disk drive, a removable storage medium, combinations thereof, and the like. Moreover, the memory 306 is intended to encompass network memory and/or other storage devices in wired or wireless communication with the LBFS 108, which may utilize the network interface 300 to facilitate such communication. Thus, any of the data, applications, and/or software described below can be stored within the memory 306 and/or accessed via network connections to other data processing systems (not shown) that may include a local area network (LAN), a metropolitan area network (MAN), or a wide area network (WAN), for example.

Accordingly, concepts of the present disclosure may operate on the LBFS 108, wherein the LBFS 108 is configured as a server to one or more client data processing systems as dictated by a client/server model. In some embodiments, for example, the LBFS 108 serves data to a web server such as, for example, a web-based feedback system server operating on the Internet and/or a private network, and may pass through additional entities such as, for example, relaying servers, firewalls, security devices, and the like. The illustrated memory 306 can include one or more applications 308 and/or other data 310.

The applications 308 can include various programs, routines, subroutines, algorithms, software, tools, and the like (“instructions”), for providing location based feedback services. The applications 308 can be executed by the LBFS 108 to recognize data received as location information, feedback data, a request for location information, a request for feedback data, promotional information, combinations thereof, and the like. The data, and/or requests for the data, can be received from the device 106, the location server 104, the LBPS 110, a server, or another device or network node, and can be received directly, or via another network node, such as, for example, a firewall or other network security device. The applications 308 also can include instructions for determining notification delivery options, evaluating location data, promotional data, and/or feedback data, and for generating, sending, or triggering delivery of notifications or data to one or more elements of the communications network 102. The applications 308 also can include instructions for performing other functions associated with the LBFS 108. These and other functions of the LBFS 108 are described in more detail below.

The applications 308 also can include instructions used to operate the LBFS 108 and/or devices connected to the LBFS 108, if any. The instructions can include, for example, operating systems, firmware, drivers for peripherals, and the like. The applications 308 also can include, for example, authentication software, billing applications, charging applications, monitoring applications, usage tracking applications, and the like.

The other data 310 can include, for example, billing information, roaming partner lists, charging applications, account data, user device data, participating partner lists, location-entity association data, software, programs, algorithms, hardware data, network utilization data, and the like. In some embodiments, the other data 310 includes account/device data that relates to one or more devices 106 and/or an account associated with a user of the device 106. The account/device data can include, but is not limited to, data indicating users' subscription plans, users' subscription features, users' preferences, capabilities of users' devices 106, users' privacy preferences, users' feedback service preferences, combinations thereof, and the like.

The LBFS 108 can be in communication with one or more charging platforms and/or other network nodes, to send and/or receive the account/device data relating to a user's subscription plan, usage, and charging and/or billing information. The LBFS 108 can analyze the account/device data to determine what features and services the user's device 106 supports by examining data relating to the device 106, for example, one or more of the international mobile subscriber identity (IMSI) or the international mobile equipment identity (IMEI), the serial number, a carrier, a software version(s), a firmware information, one or more carrier-specific applications, combinations thereof, and the like. Additionally, the LBFS 108 can analyze the account/device data to determine what features and services the user is entitled to request and/or use. For example, the account device data can indicate if the device 106 supports WIFI®, WIMAX®, 4G, 3G, 2G, EDGE, GPS, A-GPS, location based services, short message service (SMS) messaging, multimedia message service (MMS) messaging, email messaging, data transfer services, network triangulation, BLUETOOTH®, NFC, audible navigation instructions, web formats, audio formats, video formats, data transfer of audio files and video files, and the like. Additionally, the account/device data can indicate whether services for the device 106 are charged/billed on a pre-paid and/or post-paid basis, or if features are available on the device 106.

The account/device data can pass through the LBFS 108, or can be stored, at least temporarily, by the LBFS 108. Additionally, billing, privacy, safety, and/or other concerns can be used to tailor functionality of the LBFS 108 through the account/device data. For example, a user can disable the functionality of the LBFS 108 and store a preference indicating disablement of the LBFS 108 as an account setting stored in the account/device data. Additionally, the LBFS 108 can use billing information to adjust functionality of the LBFS 108. For example, a notification can be sent from a billing platform to the LBFS 108 and the LBFS 108 can disable and/or enable functionality, place limits on usage amounts, and the like, automatically. A user can be given the ability to override deactivation of some, none, or all desired features and/or functionality of the LBFS 108.

The other data 310 also can include a charging module (not illustrated) that can be used to track, collect, and/or report activities of the LBFS 108 to a charging and/or billing platform at the LBFS 108, or elsewhere on the communications network 102 for charging and/or billing purposes. The charging module can track, for example, how much data is sent and received by the LBFS 108, and can report this information to a charging and/or billing system of the communications network 102, for example. In some embodiments, entities for which feedback is submitted are charged and/or billed for feedback services provided. In some embodiments, users who submit feedback are charged for submitting feedback. Charging and/or billing can be pre-paid or post-paid. The functionality of the LBFS 108 can be charged on any desired basis, including, but not limited to, a per-use basis, as a flat fee, as part of service package, as part of a fee for an enhanced telephone or web listing, or the like.

Although not illustrated in FIG. 3, the applications 308 also can include verification modules. The verification modules can review and/or analyze, for example, requests for location information, location information, and/or identification information, and the like. The verification modules can perform various analyses on the information and/or information requests. For example, the verification modules can determine if information requests come from authorized requestors, if the information is likely being requested for a legitimate purpose, if the requested information is available, if the requested information should be provided, and the like. These and other functions will be described in more detail below.

As mentioned above, the general physical architecture of the LBPS 110 can be similar to the general physical architecture of the LBFS 108. The LBPS 110 can include a processor for executing computer readable instructions stored at a memory of the LBPS 110, or associated with the LBPS 110. The storage device associated with the LBPS 110 can store applications, e.g., computer readable instructions, for making the LBPS 110 operable to perform the functions described below. The instructions can include, for example, a user identifier application for extracting, storing, and/or appending a user identifier to/from feedback, promotions, and/or promotional messages. The instructions also can include feedback sorting applications for sorting received feedback and/or generating statistics such as average ratings based upon the received feedback and feedback publishing applications for publishing the feedback and/or transmitting the feedback, or sorted feedback and/or statistics, to another device such as, for example, a web server or database associated with a business listing entity.

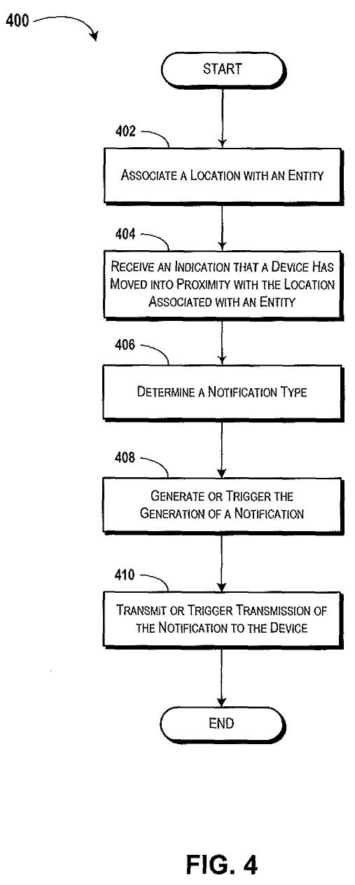

FIG. 4 schematically illustrates a method 400 for inviting a user to submit feedback for a business, according to an exemplary embodiment of the present disclosure. It should be understood that the steps of the method 400 are not necessarily presented in any particular order and that performance of some or all of the steps in an alternative order(s) is possible and is contemplated. The steps have been presented in the demonstrated order for ease of description and illustration. Steps can be added, omitted and/or performed simultaneously, without departing from the scope of the appended claims. It also should be understood that the illustrated method 400 can be ended at any time and need not be performed in its entirety.

Some or all steps of the method 400, and/or substantially equivalent steps, can be performed by execution of computer-readable instructions included on a computer-readable medium. The term “computer-readable medium” and variants thereof, as used in the description and claims, can include volatile and/or non-volatile, removable and/or non-removable media such as, for example, RAM, ROM, EEPROM, flash memory or other memory technology, CD ROM, DVD, or other optical disk storage, magnetic tape, magnetic disk storage or other magnetic storage devices, or other media that can be used to store the computer-readable instructions.

The method 400 begins, and flow proceeds to block 402, wherein a location can be associated with an entity. It should be understood that the entity can be almost any type of entity, for example, a restaurant, a store, a healthcare facility, a car dealership, a professional services office, and/or another business, a healthcare provider, a business, a government entity, a city, town, or metropolitan area, or another entity. In some embodiments, systems and methods of the present disclosure are provided as an enhanced business listing service in a business telephone directory. As such, any entity that wishes to be listed in a directory such as, for example, THE YELLOW PAGES®, can be an entity for purposes of the specification and claims.

The location associated with the entity can be defined in a number of ways. In some embodiments, the location is associated with the entity by defining GPS coordinates within which the entity is located. In some embodiments, a WIFI® device, a BLUETOOTH® device, a WIMAX® device, and/or other short range or long range radio sources are associated with the entity. In some embodiments, the associated location can be defined by a cell ID, a tower ID, a serving BTS, a service BSC, or other communications network-based device and/or information. It will be appreciated that the location information needed to define the entity can be determined based upon the number of surrounding entities, the size of the entity's business location, and the like. In some embodiments, the location associated with the entity includes a vehicle, for example, a taxi, a restaurant, a grocery store, a business, a town or city, a metropolitan area, a business facility, a hospital, a stadium or coliseum, or another location and/or area, zone, or region associated with the entity.

In a first non-limiting example, an entity includes a city or city government that is seeking to attract new residents and/or businesses to the city. As such, the city, or the city government, may participate as an entity and associate a large geographic area with the city. For example, a device that servers a large geographic area, for example, a cell or sector ID of a cellular transmitter, a cell tower, a BTS, a BSC, or another device can be associated with the entity. In a second non-limiting example, a restaurant participates as an entity and associates its dining room with a WIFI® device located at or near the dining room.

It should be appreciated that the association of a location with an entity can occur at any time, for example, during provisioning of an advertising and/or feedback service for an entity. Additionally, it should be understood that an entity associated with a location, and/or a location associated with an entity, can be updated, supplemented, deleted, edited, and/or substituted as desired. A network device and/or a storage device, for example, the LBFS 108, the memory 306, a database (not shown), another memory device, a server, the other devices and networks 112, and/or another device, can store, edit, remove, replace, and/or update the location-entity association information.

At some time, as illustrated at block 404, the communications network 102, or a node thereof, for example, the LBFS 108, can receive an indication that the device 106 has moved into, or into proximity with, a location associated with an entity. The LBFS 108 can receive the indication from a location server, from the device 106, from an application, and/or from another network application or device. In some embodiments, for example, the LBFS 108 or a location server 104 in communication with the LBFS 108 can generate a request, for example, via a programming code function call, for location information associated with the device 106. The request for location can be a data query that includes an indication or identity of the device 106 for which location information is requested. The device 106 can be identified by, for example, an IP address, an International Mobile Equipment Identity (IMEI), an International Mobile Subscriber Identity (IMSI), a telephone number, a location, other identifying information, combinations thereof, and the like.

In some embodiments, the LBFS 108 can receive an indication of the location of the device 106, for example, a location indication submitted by a user of the device 106 via a feedback or rating application. In some embodiments, the LBFS 108 can receive an indication of the location of the device 106 from a node associated with the entity, for example, a BLUETOOTH® device, a WIFI® hotspot, a WIMAX® transmitter, or other short range and/or long range communication devices.

In some embodiments, an operator of the communications network 102, or a service provider associated with the location based feedback service, can associate an Internet Protocol (IP) address associated with a network device or radio transmitter with an entity. In some embodiments, a BLUETOOTH® beacon can be used to provide the location of the entity. The device 106 can include a BLUETOOTH® transmitter and can be set to a mode in which the device 106 is discoverable via the BLUETOOTH® transmitter. Similarly, the BLUETOOTH® beacon can be set to a discoverable mode. When the device 106 enters proximity with the BLUETOOTH® beacon, the device 106 can pair with the BLUETOOTH® beacon to allow communications between the device 106 and the BLUETOOTH® beacon.

The BLUETOOTH® beacon can, for example, send location and/or identity information to the device for forwarding to the communications network 102. For example, the BLUETOOTH® beacon can send the IP address of the BLUETOOTH® beacon, a MAC address, a broadcast name, a character string identifying a street address of the entity, or other identity and/or location information to the device 106, and the device 106 can forward the information to the communications network 102 or a device or node in communication therewith.

Additionally, or alternatively, the device 106 can send location and/or identity information to the BLUETOOTH® beacon, and the BLUETOOTH® beacon and/or a device in communication with the BLUETOOTH® beacon can transmit or forward the information to the communications network 102. For example, the device 106 can send a MAC address, a login name, an IMSI, an IMEI, a telephone number, GPS location, a network ID, or other identity and/or location information to the BLUETOOTH® beacon, and the BLUETOOTH® beacon, or a device in communication with the BLUETOOTH® beacon, can forward the information to the communications network 102 or a device or node in communication therewith.

In some embodiments, a wireless networking device is provided at the entity location and the SSID is associated with the location. This location-SSID association can be stored at a storage location, e.g., a database accessible by the device 106 or the communications network 102. The device 106 can be configured to recognize proximity with the networking device and determine or send a request to another device to determine the location of the networking device based upon, for example, the SSID associated with the networking device, to determine the location of the device 106. How a networking device such as a BLUETOOTH® beacon, wireless networking device, short or long range radio transmitter/receiver, and/or cellular communication hardware is associated with an area or location will not be described in additional detail herein. It should be appreciated that additional hardware and methodology combinations may be used to determine that a device 106 has entered or is proximate a location associated with an entity.

Although not illustrated in FIG. 4, it should be understood that given the confidential nature of a user's location, the LBFS 108 can be configured to monitor any location information request or response to ensure that location information and/or identity information associated with the device 106 is not shared with an unauthorized entity or in an unauthorized manner. As such, the LBFS 108, or a device or module associated with the LBFS 108, can include fraud protection software and/or hardware modules including, but not limited to, firewalls, anti-virus applications, anti-phishing applications, SPAM protection, request analysis applications, combinations thereof, and the like. In some embodiments, the LBFS 108 can require authentication by devices and/or users requesting location information. Fraud protection and/or authentication software, hardware, and methods will not be described herein in detail.

In some embodiments, the steps described with reference to block 404 occur in the background, i.e., without the input of a user associated with the device 106. In such embodiments, the LBFS 108 can generate, transmit, and/or trigger the generation or transmission of a notification to the device 106 that feedback may be submitted. As part of the generation or triggering the generation of the notification, the LBFS 108 can determine a notification type for the device 106, as illustrated at block 406.

For example, the LBFS 108 can determine if the device 106 supports data applications, SMS messaging, MMS messaging, push notifications, email messaging, notification telephone calls, announcements, or voicemail messages, special message short messaging, and the like, so that a compatible message format can be sent to the device 106. The LBFS 108 can use identity information associated with the device 106 to determine the user's subscription plan, the device model and capabilities, if the device 106 is currently registered with a home network, combinations thereof, and the like, which can be determined by, for example, accessing a subscriber profile repository or other database, determining a model number or manufacturer of the device 106, determining the firmware and/or operating system (OS) of the device 106, or by communicating directly with the device 106 to determining the abilities of the device 106. In some embodiments, an SMS message is sent to the device 106 under the assumption that most devices support at least SMS messaging. Other default communication methods are contemplated.

As illustrated at block 408, the LBFS 108 can format the notification, or the LBFS 108 can trigger another node, for example, a notification server, to format the notification. The formatting of the notification can include, for example, putting relevant information into a data message. The relevant information can include, for example, the entity name, the entity location, and various questions or comments that the entity wishes to have presented to the user of the device 106. For a restaurant, an exemplary notification can include, for example, a rating for a waiter or waitress, a rating for the food, a rating for the cost, a rating for the wait time, a general comments field, and the like. For a grocery store, an exemplary notification can include, for example, a rating for selection, a rating for prices, a rating for helpfulness of the staff, a rating for the location, a general comments field, and the like. It should be understood that these exemplary notifications are merely provided to illustrate the types of information that may be included in the notification, but are not provided to be limiting in any way. In other contemplated embodiments, exemplary notifications include alternative or additional information such as comments, contact and/or business information, addresses, directions, telephone numbers, graphics, menus, catalogs, discount codes, coupons, instructions, advertisements, web addresses, URL's, application links, passwords, login ID's, requests for additional information, frequently asked questions (FAQ's), and the like.

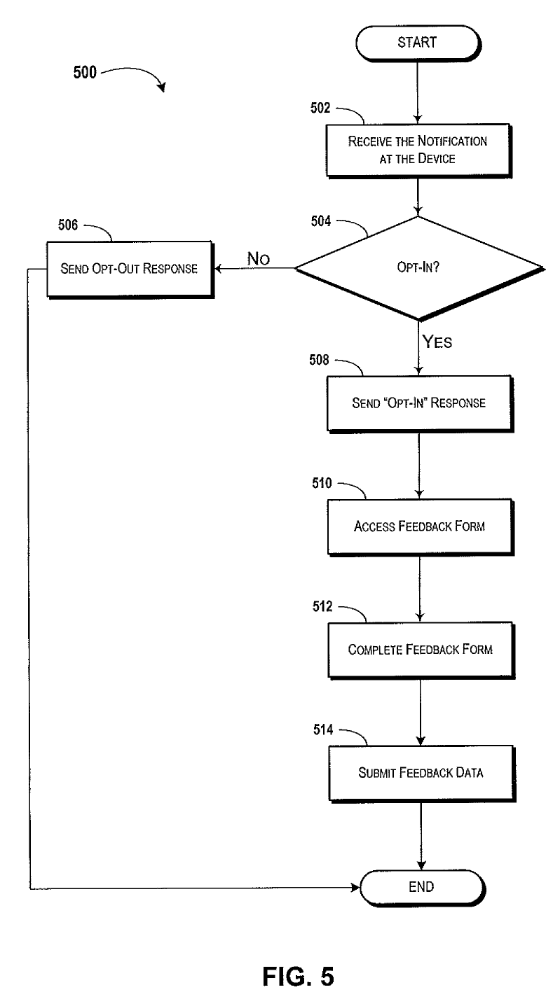

In some embodiments, the notification merely presents a user of the device 106 with an ability to “opt-in” or “opt-out” of a feedback opportunity (“‘opt-in’ notification”). An “opt-in” notification can include, for example, a URL for an online feedback form, a hotlink that starts an application at the device 106, an option to respond with a “yes” or “no,” an option to respond with “opt-in” or “opt-out,” combinations thereof, and the like. It should be understood that the “opt-in” notification also can include the data needed to submit feedback (“feedback form”). As such, if the device 106 determines to “opt-in,” the device 106 may access the feedback form without any additional communication with the LBFS 108. If an “opt-in” notification is used, whether as a separate communication or as part of the feedback form, the device 106 or a user of the device 106 can determine whether or not to “opt-in,” and a response can be sent to the LBFS 108, as will be described below with reference to FIG. 5.

As illustrated at block 410 of FIG. 4, the notification can be transmitted to the device 106 via the communications network 102. The notification can be transmitted to the device 106 by the LBFS 108, or the LBFS 108 can trigger the transmission of the notification by sending instructions to another node. In some embodiments, the LBFS 108 triggers an SMS message that is sent by an SMSC to the device 106, though other embodiments are possible and are contemplated.

As will be explained below with reference to FIG. 5, it should be understood that the LBFS 108 can send an “opt-in” notification to the device 106 and can wait for an “opt-in” response from the device 106. As such, the LBFS 108 can transmit a second notification with feedback information at block 410, if the device 106 or user of the device 106 decides to “opt-in” after receiving the “opt-in” notification. The method 400 can end.

FIG. 5 schematically illustrates a method 500 for generating location based feedback, according to an exemplary embodiment of the present disclosure. It should be understood that the steps of the method 500 are not necessarily presented in any particular order and that performance of some or all the steps in an alternative order(s) is possible and is contemplated. The steps have been presented in the demonstrated order for ease of description and illustration. Steps can be added, omitted and/or performed simultaneously, without departing from the scope of the appended claims. It also should be understood that the illustrated method 500 can be ended at any time and need not be performed in its entirety.

Some or all steps of the method 500, and/or substantially equivalent steps, can be performed by execution of computer-readable instructions included on a computer-readable medium. The term “computer-readable medium” and variants thereof, as used in the description and claims, can include volatile and/or non-volatile, removable and/or non-removable media such as, for example, RAM, ROM, EEPROM, flash memory or other memory technology, CD ROM, DVD, or other optical disk storage, magnetic tape, magnetic disk storage or other magnetic storage devices, or other media that can be used to store the computer-readable instructions.

The method 500 begins, and flow proceeds to block 502, whereat the device 106 receives a notification. The notification can be the same as, or substantially similar to, a notification generated or triggered using the method 400 illustrated in FIG. 4, or the notification can be generated in a different manner. For purposes of clarity, the method 500 will be described assuming that the device 106 receives a notification or notifications that are similar to the “opt-in” and/or second notifications described with reference to blocks 408 and 410 of FIG. 4. It should be understood that this embodiment is exemplary, as the inclusion or use of an “opt-in” message is optional in some embodiments.

At block 504, the device 106 can determine if the device 106 will “opt-in.” The device 106 can make this determination based upon a stored user preference, by reviewing an account setting, by reviewing an application setting, and/or by displaying a question for and receiving an entry from a user of the device 106. If the device 106 determines not to “opt-in,” an “opt-out” message can be sent to the LBFS 108, or another network node, as illustrated at block 506. It should be understood that the sending of an “opt-out” message is optional. In some embodiments, a device 106 “opts-out” of the feedback system or feedback opportunity simply by not “opting-in.” Similarly, where a notification includes a URL or hotlink for submitting feedback via an application or web-based feedback system, a device 106 can “opt-in” by clicking on or accessing the URL or link.

If the device 106 determines to “opt-in,” an “opt-in” response can be sent to the LBFS 108, as shown in block 508. As explained above, a notification can include a feedback form and an “opt-in” notification. Therefore, an “opt-in” response may not be sent if a device 106 determines that feedback will be submitted. Rather, the submitted feedback can essentially function as an “opt-in” response.

As illustrated at block 510, a device 106 that has determined that feedback will be submitted can access a feedback form. Accessing the feedback form can include sending an “opt-in” response and receiving a second notification from the LBFS 108 that includes the feedback form. Alternatively, accessing the feedback form can include parsing the notification to identify data in the notification that defines a feedback form. For example, the device 106 can examine the notification and identify the data that will be used to populate a feedback form generated by a feedback application, identify a URL that links to a web-based feedback form, establish a call and/or present a simple form or questions to which a user can respond via an interactive voice response (IVR) system, a feedback application, and/or messaging services such as SMS, MMS, email, and/or instant messaging (IM) services, identity other data representing a feedback form, combinations thereof, and the like.

As illustrated at block 512, the device 106 can receive the completed feedback form. Based upon the above discussion, it will be understood that the completed feedback form can include input received, for example, via a feedback application operating at the device 106 or on a server or network system in communication with the device 106, as input received at the device 106 for submission to a web-based feedback form, as input received at the device 106 for submission via a messaging service such as email, MMS, SMS, and the like, as plain text, as input received at a feedback application, combinations thereof, and the like. The feedback can be formatted as, for example, text, representative characters, graphics, and the like.

At block 514, the device 106 submits the feedback to the LBFS 108. As discussed above, the feedback can be submitted to the LBFS 108 in response to receiving a command at the device 106. The command to submit the feedback can be received, for example, by a user selecting a “submit” option of a web-based form or a “send” or “submit” option of a messaging service or feedback application used by the user. Upon receiving the command to submit the feedback, the device 106 or another device that receives the feedback, e.g., a web-based feedback server, can transmit the feedback data via a data connection with the communications network 102. As such, submitting the feedback data can include sending a message to a messaging service system at the communications network 102, establishing a data link between the LBFS 108 or another network node and the device 106 to allow direct transfer of the feedback data, interaction with an IVR, combinations thereof, and the like. In some embodiments, the device 106 formats an SMS message and transmits the SMS message to the LBFS 108 via the communications network. In some embodiments, a feedback application opens a data stream with the LBFS 108 or another network device, and transmits the feedback via the data stream. The method 500 can end.

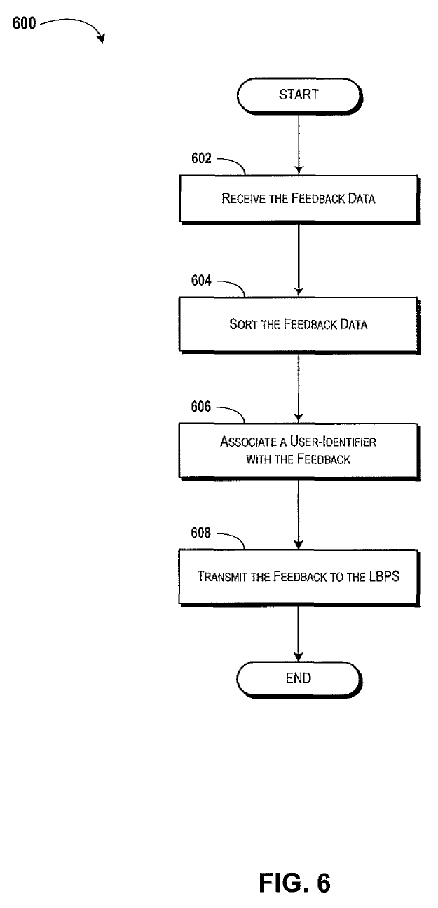

FIG. 6 schematically illustrates a method 600 for receiving location based feedback, according to an exemplary embodiment of the present disclosure. It should be understood that the steps of the method 600 are not necessarily presented in any particular order and that performance of some or all the steps in an alternative order(s) is possible and is contemplated. The steps have been presented in the demonstrated order for ease of description and illustration. Steps can be added, omitted and/or performed simultaneously, without departing from the scope of the appended claims. It also should be understood that the illustrated method 600 can be ended at any time and need not be performed in its entirety.

Some or all steps of the method 600, and/or substantially equivalent steps, can be performed by execution of computer-readable instructions included on a computer-readable medium. The term “computer-readable medium” and variants thereof, as used in the description and claims, can include volatile and/or non-volatile, removable and/or non-removable media such as, for example, RAM, ROM, EEPROM, flash memory or other memory technology, CD ROM, DVD, or other optical disk storage, magnetic tape, magnetic disk storage or other magnetic storage devices, or other media that can be used to store the computer-readable instructions.

The method 600 begins, and flow proceeds to block 602, whereat the LBFS 108 receives feedback from a device such as, for example, the device 106, a web server associated with a web-based feedback system, an SMSC, or another device. The feedback can include private data associated with the device 106, for example, an indication of the device 106 and/or a subscriber associated with the feedback, an indication of the location and time of the feedback, the type of device used to submit the feedback, combinations thereof, and the like.

As such, prior to sending the feedback to a system associated with the entity rated in the feedback, the private data can be sorted from the feedback data, as illustrated at block 604. The LBFS 108, or another network device, can sort the private data from the feedback data by executing a privacy application or other program residing at a storage location associated with the LBFS 108 or the other network device. The privacy application can include algorithms that recognize private data based upon content, location in the submitted feedback data, or using other methods. In some embodiments, the feedback is extracted or copied from the feedback data. The LBFS 108 can maintain a copy of the feedback form with the private data for data mining or analysis purposes, for tracking user habits, and the like. Privacy concerns may dictate that feedback data be deleted, stored in an encrypted form, redacted, and/or the like.

As illustrated at block 606, the LBFS 108 can append to or include with the feedback a user identifier before, as, and/or after the feedback is forwarded to the LBPS 110. The user identifier can, for example, a random character code, unique data associated with the user, an encrypted IMEI, IMSI, or telephone number, a character code, an alphanumeric string, a numeric variable, other data, combinations thereof, and the like. The LBFS 108 can store the user identifier in a database and associated the user identifier with a device identifier or other information that describes or identifies the user or device 106 associated with the feedback before sending the feedback to the LBPS 110 with the user identifier. Since the LBPS 110 will not, in such an embodiment, receive the device identifier, the feedback will be, from the perspective of the LBPS 110, anonymous.

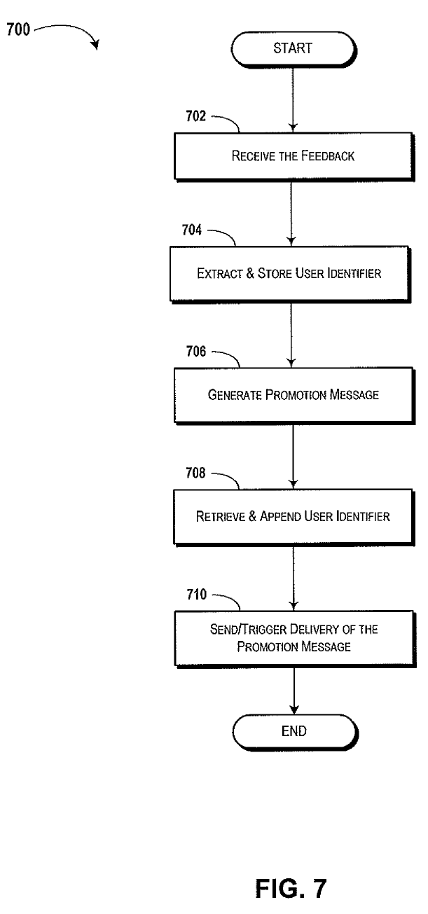

As will be explained below with reference to FIG. 7, the user identifier can be used by the LBPS 110 to send, in response to receiving the feedback, a promotion for the device 106 or the user associated with the device 106 without knowing the identification of the device 106 or the user associated with the device 106. As will be explained below, the promotion can include a copy of the user identifier received from the LBFS 108. The LBFS 108, or another network element, can use the user identifier appended to or included with the promotion to identify the user or the device 106, and can forward the promotion to the device 106 associated with the identified user.

As illustrated at block 608 (FIG. 6), the LBFS 108 can forward the feedback to the LBPS 110, or another entity associated with the entity. In some embodiments, the feedback is sent, via a messaging system, to an inbox associated with the entity. In other embodiments, the feedback is routed to a web-based feedback system where the results are sorted and/or stored. In some embodiments, the LBFS 108 sends the feedback directly to the LBPS 110 via a data link. The method 600 can end.

FIG. 7 schematically illustrates a method 700 for generating promotions, according to an exemplary embodiment of the present disclosure. The word “promotion,” as used in the description and the claims, includes all types of promotional information, data, and messages, including, but not limited to, advertisements, coupons, discount codes, information regarding special offers and/or partnerships, buyers' club offers, point program information, special offers, combinations thereof, and the like, for the entity, for a partnering or local entity, or for another entity, and/or for a product and/or service offered by an entity. The promotion can be delivered as graphics, text, messages, directions, or other desired delivery method and format.

It should be understood that the steps of the method 700 are not necessarily presented in any particular order and that performance of some or all the steps in an alternative order(s) is possible and is contemplated. The steps have been presented in the demonstrated order for ease of description and illustration. Steps can be added, omitted and/or performed simultaneously, without departing from the scope of the appended claims. It also should be understood that the illustrated method 700 can be ended at any time and need not be performed in its entirety.

Some or all steps of the method 700, and/or substantially equivalent steps, can be performed by execution of computer-readable instructions included on a computer-readable medium. The term “computer-readable medium” and variants thereof, as used in the description and claims, can include volatile and/or non-volatile, removable and/or non-removable media such as, for example, RAM, ROM, EEPROM, flash memory or other memory technology, CD ROM, DVD, or other optical disk storage, magnetic tape, magnetic disk storage or other magnetic storage devices, or other media that can be used to store the computer-readable instructions.

The method 700 begins, and flow proceeds to block 702, whereat an LBPS 110 receives feedback from the LBFS 108 or from another feedback system such as a web-based feedback system server. As explained above, private data can be removed from the feedback such that the LBPS 110 receives only the user's feedback and a user identifier, thus passing the relevant data to the LBPS 110 without divulging the user's location, identity, or other private data. Therefore, as illustrated at block 704, the LBPS 110 can extract the user identifier from the feedback. In some contemplated embodiments, the LBPS 110 can store the extracted user identifier in a memory, buffer, cache, database, or other storage device associated with or accessible by the LBPS 110.

As illustrated at block 706, the LBPS 110 can generate, or trigger generation of, a promotion intended for delivery to the device 106 associated with the feedback. The details of the promotion can be based upon the mere submission of the feedback, or can be based upon the feedback received. In some embodiments, for example, the LBPS 110 sends a promotion in response to any received feedback. In some embodiments, the LBPS 110 analyzes the feedback and generates the promotion based upon the actual content of the feedback.

In some embodiments, the LBPS 110 includes a feedback analysis application that is provided by execution, by a processor associated with the LBPS 110, of computer readable instructions stored at a storage location accessible by the LBPS 110. The feedback analysis application can analyze the feedback based upon a variety of factors. In some embodiments, the feedback analysis application can analyze the feedback based, for example, upon the percentage of questions answered or not answered, the presence or absence of additional comments, the amount of time that between the time the feedback data request is initially sent to the device 106 and the time at which the feedback is received at the LBFS 108, the percentage of positive or negative comments present in the feedback, the amount of money spent by the user at the entity rated by the feedback, the type of device used to submit the feedback, the user identifier, the time of day, the location of the device at the time the feedback is submitted, combinations thereof, and the like.

The LBPS 110 can, for example, base the entity associated with the promotion on the type of services or products provided by the entity and/or a partnering entity, the location of the entity and/or a partnering entity, and the like. Relationships between the entity and a partnering entity can be determined and/or established by the entities, a user, and/or a service provider. Such relationships can be indicated by data stored at or by a storage device associated with the LBPS 110, the LBFS 108, and/or another storage device such as, for example, a database, the memory 306. In some embodiments, a computer or other device associated with a location beacon transmits information regarding such a relationship to the device 106 and/or the communications network 102.

In a non-limiting example, a user may submit feedback for a pizza restaurant that participates in the location based feedback service as an entity. An operator of the communications network 102, the pizza restaurant, or another authorized party, can identify a partner to associate promotions with, for example, a beer store near the pizza restaurant. As such, a customer who purchases a pizza may receive a request to submit feedback for the pizza store. If the customer submits feedback regarding the pizza store, the customer can receive a promotion providing a discount for beer at the beer store. This example is merely exemplary and is provided solely for purposes of illustrating the concepts of the disclosure, and not to limit the scope of the disclosure and/or claims in any way.

As illustrated at block 708, the user identifier can be appended to or included with the promotion to allow later identification of the device 106 or the user of the device 106. For example, if a user identifier was sent with the feedback and was stored at the storage location or device, the user identifier can be retrieved from the storage location or device and can be appended to or included with an outgoing message to allow later identification of the device 106 or a user of the device 106 by another entity such as, for example, the LBFS 108.

As illustrated at block 710, the promotion can be transmitted to the device 106 via the communications network 102. In some embodiments, the promotion is transmitted to the device 106 by the LBPS 110. In some embodiments, the LBPS 110 triggers the transmission of the promotion by sending instructions to another node operating on the communications network 102. For example, the LBPS 110 can instruct an SMSC, an MMSC, or another messaging platform to send a promotion to the device 106 as one or more messages, for example, as messages formatted according to the SMS protocol, the MMS protocol, as email messages, and/or as messages formatted in other protocols. The promotion can include a coupon code, a special offer, information regarding upcoming sales or other offers, other promotions, combinations thereof, and the like, and can be sent as text, graphics, email messages, links to printable coupons, bar codes, or other indicia. In some embodiments, the promotions are appended or attached to the promotions.

Though not illustrated in FIG. 7, delivery of the promotion to the recipient device 106 can, in some embodiments, include the use of additional network node and/or elements. As explained above, the promotion can include the user identifier, which can be appended to the promotion by the LBPS 110. The promotion can be sent to a network node, for example, the LBFS 108 or other device. The network node can use the user identifier to access the storage location at which the user identifier and the user's identity are associated and stored. The network node can access the user identity and deliver or trigger delivery of the promotion to the device 106 associated with the user identity. The method 700 can end.

Although not discussed in detail above, areas, regions, or zones at, near, or proximate the location associated with an entity (hereinafter “area”) can be defined, and the area can be associated with the entity in addition to, or instead of, the location discussed above. In some embodiments, the area includes a zone that extends from 10 to 100 feet around an entity. Including such a zone can help identity devices that are at or near the entity despite inherent error in the devices and/or methods used to determine the location of a device. In some embodiments, for example in the example of a city or metropolitan area, the area can include a zone that extends from 1 to 10 miles around the city.

It should be appreciated that the area can be defined based upon the location methods and/or hardware used to determine location of a device, by the size of a parking lot associated with an entity, based upon preferences of a party associated with the entity, and the like. As such, the area can extend from 10 to 100 feet, from 5 to 50 meters, from 100 feet to 1000 feet, from 1000 feet to 10 miles, and/or any other desired dimensions. The word “proximate,” as used in the claims to describe the relationship between a device and an entity location, includes all embodiments described and disclosed herein, including entity locations defined with or without the areas or zones described immediately above.

In some embodiments, the communications network 102 includes a Customer Loyalty/Recommender System (CLRS). The CLRS can include the LBFS 108 and/or the LBPS 110, and/or can perform some or all of the functions described above with reference to the LBFS 108 and/or the LBPS 110. In some embodiments, the CLRS is the LBPS 110, in some embodiments the CLRS is the LBFS 108, and in some embodiments, the CLRS is both the LBFS 108 and the LBPS 110.

In some embodiments, for example, the CLRS stores all received feedback. The feedback can be stored at a storage device at, in communication with, and/or associated with the CLRS. As such, the CLRS can serve as or function as the primary repository of feedback from all the users in communication with the system. Additionally, the CLRS can maintain promotions offered by entities, partners, and/or other third parties. The promotions can be stored at the CLRS and/or at a storage device accessible by the CLRS. Additionally, the CLRS can send or trigger the sending of a promotion to a user or device 106. The sending of promotions can be based upon the feedback received from a user and/or feedback received from all users who submit feedback. In other words, the CLRS can analyze feedback received from users alone, or in conjunction with other feedback, thereby rating feedback on its own, or in comparison to other received feedback.

In some embodiments, the LBFS 108, the LBPS 110, and/or the CLRS will receive only anonymous information about a user. For example, the LBFS 108, the LBPS 110, and/or the CLRS may only know that the client from which feedback was received frequents their establishment.

In some embodiments, the communications network 102, the LBFS 108, the LBPS 110, and/or the CLRS includes or is in communication with a social server. The social server can be performed by the execution of computer-readable instructions. As such, the social server can be a combination hardware and software, for example, a network node, a server on the Internet, a server on a private network, combinations thereof and the like.

The social server can determine and/or collect patterns relating to users and/or use of the location based feedback service. The social server can be authorized to collect additional information, for example, the private data discussed above, and correlate this private data with feedback and/or location information. For example, the social server may analyze the user's age, lifestyle, hours of greatest activity, device type and/or capabilities, shopping habits, texting and/or other device or device features usage habits, combinations thereof, and the like. A carrier operating the location based feedback service, or another entity hired by the carrier, can analyze and/or store this information for purposes of data mining, making recommendations, and/or other purposes. The carrier also can determine the best programs for a user based upon this information, and can provide direction to an entity regarding promotions. As mentioned above, a user's private information can be kept confidential, so the carrier or other party can provide the entity with information without divulging the user's private information.

As such, an entity can receive information from a network operator, carrier, or other party operating a location based feedback service, that the user at the entity is a loyal customer, for example. This can allow the entity to consider customer loyalty before extending a promotion to the user.

As explained above, the LBFS 108, the LBPS 110, the CLRS, the social server, and/or other networks and nodes 112 can be operated by the same or different parties. As such, the various nodes and systems described hereinabove can be separated by the Internet and/or other networks. Alternatively, substantially all of the functions of the LBFS 108, the LBPS 110, the CLRS, the social server, and/or the other networks and nodes 112 can be performed by a unitary device, if desired.

The law does not require and it is economically prohibitive to illustrate and teach every possible embodiment of the present claims. Hence, the above-described embodiments are merely exemplary illustrations of implementations set forth for a clear understanding of the principles of the disclosure. Variations, modifications, and combinations may be made to the above-described embodiments without departing from the scope of the claims. All such variations, modifications, and combinations are included herein by the scope of this disclosure and the following claims.

What is claimed is:

1. A system for obtaining location based feedback from a device operating on a communications network, the system comprising:
a location based feedback server comprising a memory for storing computer-readable instructions, executable by a processor to make the location based feedback server operable to:
receive location information indicating a location at which the device is located;
compare the location information to location data indicating an entity location, the entity location being associated with an entity that participates in the location based feedback service;
determine that the device is proximate the entity location;
transmit a feedback data request to the device, the feedback data request comprising a request for the device to submit feedback relating to the entity;
extract feedback from feedback data received from the device, the feedback data comprising the feedback and identification information relating to the device;
send the feedback to a location based promotion server.

2. The system of claim 1, wherein the computer-readable instructions further comprise instructions, executable by a processor to make the location based feedback server operable to determine a delivery type supported by the device prior to transmitting the feedback data request to the device according to the delivery type.

3. The system of claim 2, wherein the computer-readable instructions for generating and transmitting the feedback data request further comprise computer-readable instructions, executable by a processor to make the location based feedback server operable to:
generate an “opt-in” notification for delivery to the device;
recognize received data as an “opt-in” response sent by the device; and
transmit to the device, in response to the “opt-in” response, the feedback data request, wherein the feedback data request comprises a feedback form.

4. The system of claim 1, wherein the computer-readable instructions further comprise instructions, executable by a processor to make the location based feedback server operable to extract the identification information from the feedback data received from the device.

5. The system of claim 4, further comprising computer-readable instructions, executable by a processor to make the location based feedback server operable to:
generate a user identification;
store the user identification and a device identifier in a storage location accessible by the location based feedback server; and
associate the user identifier with the feedback to create anonymous feedback.

6. The system of claim 5, wherein the computer-readable instructions, executable by a processor to make the location based feedback server operable to send the feedback to the location based promotion server by sending the anonymous feedback to the location based promotion server.

7. The system of claim 1, further comprising computer-readable instructions, executable by a processor to make the location based feedback server operable to receive a promotion from the location based promotion server.

8. The system of claim 6, further comprising computer-readable instructions, executable by a processor to make the location based feedback server operable to:
receive a promotion from a location based promotion server, the promotion comprising the user identifier;
determine the device identifier by accessing the storage location and retrieving the device identifier associated with the user identifier; and
transmit the promotion to the device.

9. The system of claim 6, wherein the location information comprises data obtained at the device using a Global Positioning Service (GPS) receiver.

10. A method for providing a location based feedback service to a device operating on a communications network, the method comprising:
associating an entity location with an entity that participates in the location based feedback service;
storing, at a storage device, data indicating the entity location and the associated entity;
receiving location information indicating a location at which the device is located;
comparing, at a location based feedback server, the location information to the entity location;
determining, based upon the comparing, that the device is proximate the entity location;
transmitting a feedback data request to the device, the feedback data request comprising a request for the device to submit feedback relating to the entity;
extracting feedback from feedback data received from the device, the feedback data comprising the feedback and identification information relating to the device; and
sending the feedback to a location based promotion server.

11. The method of claim 10, further comprising:
generating an “opt-in” notification for delivery to the device;
recognizing data received at the location based feedback server as an “opt-in” response sent by the device; and
transmitting to the device, in response to the “opt-in” response, the feedback data request, wherein the feedback data request comprises a feedback form.

12. The method of claim 10, further comprising:
generating a user identification;
storing the user identification and a device identifier in a storage location accessible by the location based feedback server; and
appending the user identifier to the feedback to create anonymous feedback.

13. The method of claim 10, wherein transmitting the feedback data request to the device comprises triggering delivery of the feedback data request.

14. The method of claim 10, further comprising sending the feedback to a system associated with the entity.

15. The method of claim 10, wherein associating the entity location with the entity comprises storing location data corresponding to a geographic location and indicating that the geographic location corresponds to a place of business associated with the entity.

16. The method of claim 12, further comprising:
receiving, at the location based feedback server, a promotion comprising the user identifier;
determining the device identifier by accessing the storage location and retrieving the device identifier associated with the user identifier; and
transmitting the promotion to the device.

17. The method of claim 14, further comprising charging a fee to the entity for the feedback.

18. The method of claim 15, wherein:
the location data comprises an Internet Protocol (IP) address of a short range radio beacon; and
receiving location information comprises receiving an indication that the device is within a transmission range of the short range radio beacon.

19. A computer readable medium comprising computer readable instructions that, when executed, cause a location based feedback server to perform a method comprising:
storing, at a storage device, data indicating an entity location and an entity associated with the entity location, the entity comprising an entity that participates in a location based feedback service;
receiving, at the location based feedback server, data indicating a location of a mobile communications device;
comparing, at the location based feedback server, the location information to the entity location to determine that the device is at the entity location;
recognizing data received at the location based feedback server as feedback data received from a mobile communications device, the feedback data comprising feedback and identification information relating to the device, and being received in response to a feedback data request sent to the device;
extracting, at the location based feedback server, feedback from the feedback data; and
sending the feedback to a location based promotion server.

20. The computer readable medium of claim 19, further comprising computer readable instructions that, when executed, cause the location based feedback server to perform the method further comprising:
receiving, at the location based feedback server, a promotion for the device; and
transmitting the promotion to the device.
